(19) United States
(12) Patent Application Publication
(10) Pub. No.: US 2005/0199175 A1
(43) Pub. Date: Sep. 15, 2005

(54) Luminous vehicle antenna topper

(76) Inventors: Reidar Saito Aamotsbakken, Madison, WI (US); Charles Richard Heidenreich, Madison, WI (US)

Correspondence Address: Reidar Saito Aamotsbakken, 668 Pickford Street, Madison, WI, 53711, US

(21) Appl. No.: 10/799,553

(22) Filed: Mar. 9, 2004

(51) Int. Cl. B60Q 11/00

(52) U.S. Cl. 116/28 R

(57) ABSTRACT

A luminous antenna topper includes a luminous ornamental element which is capable of being secured to the antenna of a vehicle, is energized by ambient light, and glows in the dark once energized. The ornamental element can be hollow or solid. Solid ornamental elements include a centrally disposed bore sized to frictionally engage the antenna and can be made luminous by incorporation of phosphorescent powder in the base material, or by incorporating an outside layer of phosphorescing material. A hollow ornamental element includes a plurality of support members attached to the interior thereof to define an aperture, and can be made luminous by incorporation of phosphorescent powder in the base material, or by incorporating an outside layer of phosphorescing material. The antenna topper can be in the form of sports balls, sports helmets, expressioning faces, animals, action figures, etc. The antenna topper can be constructed of various lightweight materials such as plastic, rubber, Styrofoam, epoxy, polyurethane, incorporating the phosphorescing material on the outside or throughout.

### REFERENCE TO RELATED APPLICATIONS

| | | |
|---|---|---|
| 4526820 | July, 1985 | Haas. |
| 4624211 | November, 1986 | Jokel. |
| 4881485 | November, 1989 | Feinberg. |
| 4901662 | February, 1990 | Sandeen et al. |
| 4964360 | October, 1990 | Henry |
| 4972795 | November, 1990 | Mace. |
| 4989536 | February, 1991 | Liming et al. |
| 5078075 | January, 1992 | Liming et al. |
| 5176099 | January, 1993 | Katz et al. |
| 5572225 | November, 1996 | McCarthy |
| 5836261 | August, 1997 | Sutton |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to an inexpensive luminous vehicles antenna topper which can be readily retrofitted to stationary antennas for the purpose of identification of one's vehicle from afar.

2. Description of the Prior Art

It is common practice for motorists to park their vehicles in large parking facilities such as those located in shopping malls, entertainment stadiums, airports, etc. On such occasions, it is imperative that the motorist remember the location of the parked vehicle. On most occasions, however, the motorist is more concerned with remembering information pertaining to the event or task for which he or she has travelled. Consequently, very little attention is paid to the location where the vehicle is parked. This is especially true when the motorist has borrowed or leased the vehicle which he or she is driving.

There are also situations where a motorist quickly parks a vehicle, promptly forgets its location, and has no idea where it is upon returning to find the vehicle. A classic example occurs when returning from a business trip or vacation, wherein the motorist attempts to locate the vehicle in a large parking facility after a few days, a week, or even longer. The same confusion often occurs after sporting or entertainment events.

It is also important to be able to quickly and effectively identify a vehicle or vehicles which do not belong to the driver. For example, a motorist who borrows a vehicle from a friend or leases a vehicle from a commercial concern will often find it difficult to identify the vehicle in a large parking facility or an area where several similar models are parked.

Various ornamental markers and the like exist for identifying and distinguishing vehicles.

For example, U.S. Pat. No. 4,526,820 issued on Jul. 2, 1985, to Haas describes a plastic ornamental marker for vehicle antennas consisting of a pair of engageable marker members having a common channel to surround the antenna. An adhesive is provided on the inner mating surfaces of the marker members to secure the marker on the antenna. Printed indicia or integrally formed indicia are provided for identification. Alignment structure for the marker is made up of dowel pins in one half and matching sockets in the other half. This marker cannot be removed and reattached to the antenna.

U.S. Pat. No. 4,624,211 issued on Nov. 25, 1986, to Jokel describes an attachment device for attaching a ribbon, flag or a metal cylinder to a vehicle antenna. Two threaded and channeled screws fit over the antenna stem and are connected by a sleeve which encloses the ball tip. The lower screw has a nut and a machine screw to secure it to the stem. The upper rod screw has a slot and another nut to secure a marker ribbon or the upper string of a flag. The lower string of the flag is looped around the antenna stem. A metal cylinder can be fitted with a brazed nut on its bottom surface to attach to the upper screw. This attachment device is all metal in construction and involves many parts, whereas the instant invention involves a single element and does not require fasteners.

U.S. Pat. No. 4,881,485 issued on Nov. 21, 1989, to Feinberg describes an ornamental vehicle identification device in the form of a disposable container such as a topless cigarette box or an opened soft drink can with streamers attached in the openings. The box and the can are attached to a suction cup by a shaft and hook, respectively. This ornamental device is placed on the roof of a vehicle. The object of this invention is to use discarded materials in order to lessen the loss by theft or the elements. The instant invention is durable and requires less preparation for mounting.

U.S. Pat. No. 4,972,795 issued on Nov. 27, 1990, to Mace describes a football helmet antenna marker device which can have a goal post attached on top of the helmet. The antenna is secured at the terminal end in the helmet or in the goal post by a plurality of opposed, axially aligned thumb screws. The helmet is filled with foam rubber. The instant invention requires no such fastening to the antenna.

U.S. Pat. No. 4,989,536 issued on Feb. 5, 1991, to Liming et al. describes a three-piece swiveling antenna clamp for displaying a banner from its looped cord. The cylindrical clamp has complementary halves configured to envelop the antenna with its ball tip, and the halves are held together by a plastic cap coextensive with the halves. An alternative clamp embodiment has an extra interlocking top cap seal. This clamp has three parts and is limited to holding a looped cord.

U.S. Pat. No. 5,176,099 issued on Jan. 5, 1993, to Katz et al. describes an antenna ball for identification of a vehicle. The ball has two interlocking hemispheres wherein one half has a peripheral lip and two hooks which mate with the lip and apertures of the other half. The innovation is based on attachment and removal for storage in the glove compartment. The ball can be made of a light, durable plastic, metal, wood or styrofoam. The ball can have a symbol, a number or an advertisement. In direct contradistinction thereto, the instant invention is one-piece and can still be attached to and detached from a vehicle antenna without the need for interlocking parts which deteriorate with use and age.

None of the above inventions and patents, taken either singly or in combination, is seen to describe the instant invention as claimed.

### BRIEF SUMMARY OF THE INVENTION

In accordance with the objects of the invention, a luminous vehicle antenna topper is provided for use in conjunction with a fixed vehicle antenna. The luminous antenna topper includes an ornamental element which is capable of being secured to the antenna of the vehicle. The ornamental element can be hollow or solid. Solid ornamental elements include a centrally disposed bore which is sized to frictionally engage the antenna. A hollow ornamental element includes a plurality of support members attached to the interior thereof. The ornamental antenna topper is made wholly of a material incorporating a phosphorescing material or its outside is coated with such a material. The ornamental element can be in the form of sports balls, expressioning faces, animals, etc. The ornamental element can also be constructed of various lightweight materials such as plastic, rubber, styrofoam, epoxy, polyurethane, etc. Accordingly, it is a principal object of the invention to provide an economical but effective luminous vehicle antenna topper. It is another object of the invention to provide either a hollow or solid luminous antenna topper capable of being retained on the antenna during normal driving. It is an object of the invention to provide improved elements and arrangements thereof in an apparatus for the purposes described which is inexpensive, dependable and fully effective in accomplishing its intended purposes.

### BRIEF DESCIPTION OF THE SEVERAL VIEWS OF THE DRAWINGS

Not Applicable

### DETAILED DESCRIPTION OF THE INVENTION

Since shape of the ornamental antenna topper is not an issue, no figures are provided herein. The ornamental luminous vehicle antenna topper can be moulded from a plastic mixture such as epoxy or polyurethane, containing a fraction of a phosphorescing powder with a concentration up to the saturation point for said mixture prior to curing. The ornamental luminous vehicle antenna topper can also be made luminous after manufacture, by coating the antenna topper with a material such as paint or a plastic material containing a phosphorescing powder of a concentration up to the saturation point of said mixture. The phosphorescing powder can be chosen from many colors and many glow characteristics. The most attractive phosphorescing powder would remain luminous at high intensity for hours after being fully energized by sunlight or another artificial light source.

The present invention provides for inexpensive, durable, one-piece luminous vehicle antenna toppers which can be added to conventional fixed vehicle antennas that are used for AM and FM radio reception. There is a need for such marking devices which are also attractive and selectively unique so as to enable the vehicle owner to readily locate the

1. A luminous vehicle antenna topper for engaging the end of a vehicle antenna, the luminous vehicle antenna topper comprising:
An ornamental element having a hollow interior and having an opening for retaining the antenna, said ornament having an internal support structure to keep it in place, being constructed of a base material incorporating a phosphorescing material, or being covered by a material incorporating a phosphorescing material.
An ornamental element having a solid interior and having an opening for retaining the antenna, said ornament being constructed of a base material incorporating a phosphorescing material, or being covered by a material incorporating a phosphorescing material.
